(19) United States
(12) Patent Application Publication
(10) Pub. No.: US 2012/0142219 A1
(43) Pub. Date: Jun. 7, 2012

(54) CONTROL DEVICE AND CONTROL SYSTEM USING THE SAME

(75) Inventors: WAN-JUN JIANG, Shenzhen City (CN); CHUN-WEI PAN, Tu-Cheng (TW); GANG WANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/095,874

(22) Filed: Apr. 28, 2011

(30) Foreign Application Priority Data
Dec. 4, 2010 (CN) 201010573492.5

(51) Int. Cl. H01R 13/66; H01H 13/76

(52) U.S. Cl. 439/620.01; 200/5 A

(57) ABSTRACT

A control device includes a plug, a number of resistors and a number of switches, and a number of buttons corresponding to the switches respectively. The resistors and the switches cooperatively form a plurality of current circuits. A control system using the control device includes an electronic device, which includes a socket connected to the plug. The socket includes an ADCIO pin coupled to the first pin, which connects to a power source via a pull-up resistor. A connection node between the ADCIO pin and the pull-up resistor forms a voltage detection point. When the control device is connected to the electronic device, if one of the buttons is pressed, the switch corresponding to the pressed button is switched on to generate a corresponding conductive current circuit, and generate an input signal at the voltage detection point. The electronic device executes a corresponding function according to the input signal.

### BACKGROUND

1. Technical Field

The present disclosure relates to a control device and a control system using the same.

2. Description of Related Art

With the development of miniaturization, and the trend towards the portability of electronic devices, a number of functions that are added, such as music, video, e-book reading, to the electronic devices, to make electronic devices user-friendly. In the meantime, adding more functions to the accessories of electronic devices also becomes an increasingly popular trend. However, to achieve complex functions, the accessories often have complex circuits, which will increase the production costs of the accessories.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic view of a control system including a control device and an electronic device, according to an embodiment.

FIG. 2 is an exemplary circuit diagram of the control device and the electronic device of FIG. 1.

FIG. 3 is another exemplary circuit diagram of the control device and the electronic device of FIG. 1.

### DETAILED DESCRIPTION

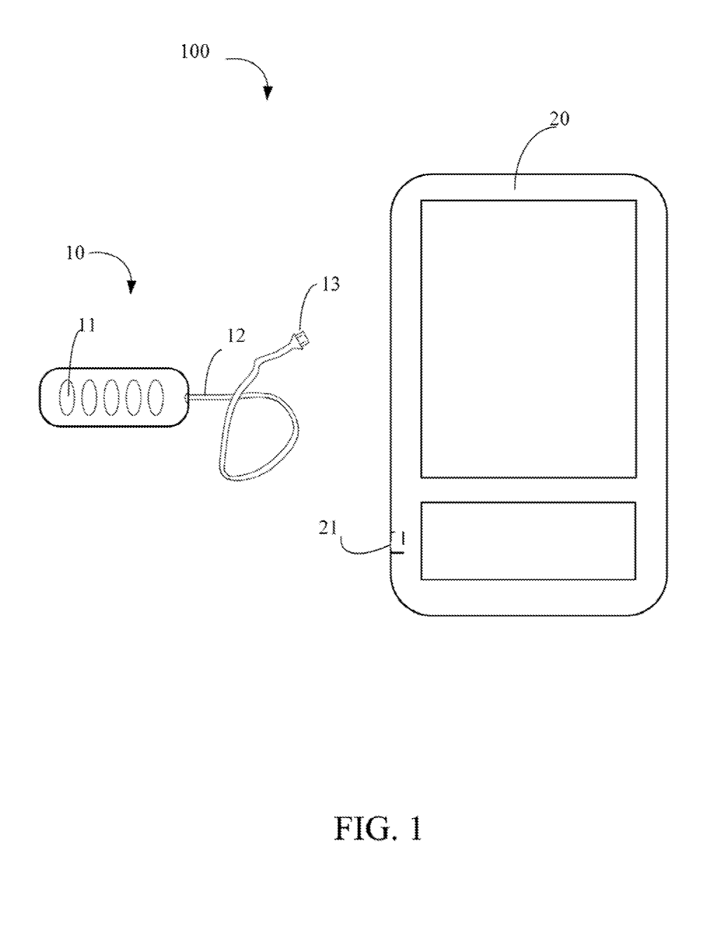

Referring to FIG. 1, a control system 100 includes a control device 10 and an electronic device 20. The control device 10 is configured for wired remote controlling the electronic device 20. The control device 10 includes a number of buttons 11, a cable 12, and a plug 13. The buttons 11 can be push buttons or touch-buttons. The electronic device 20 includes a socket 21. The control device 10 can be connected to the electronic device 20 with the plug 13 being coupled to the socket 21. Users can control the electronic device 20 to execute a function by pressing the corresponding button 11.

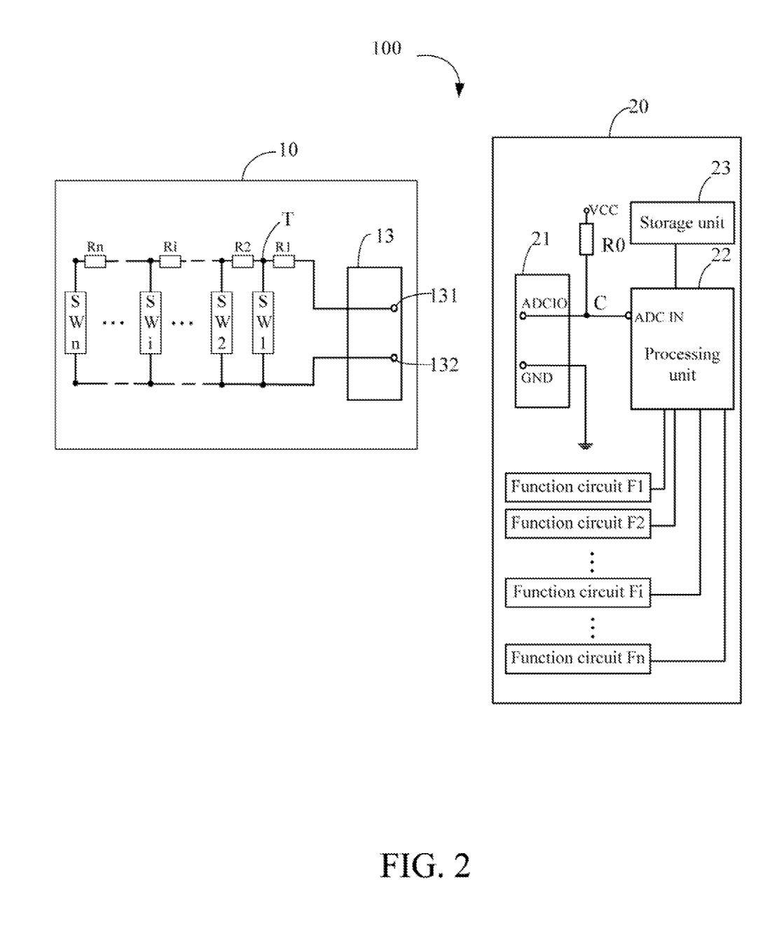

Referring to FIG. 2, the plug 13 at least includes a first pin 131 and a second pin 132. Corresponding to the plug 13 of the control device 10, the socket 21 at least includes an analog-to-digital conversion input/output (ADCIO) pin coupled to the first pin 131 of the plug 13, and a ground (GND) pin 132 coupled to the second pin 132 of the plug 13. In the embodiment, the ADCIO pin of the socket 21 connects to a power source VCC via a pull-up resistor R0. A connection node between the ADCIO pin and the pull-up resistor R0 forms a voltage detection point C. The GND pin of the socket 21 is grounded.

The control device 10 further includes a number of resistors R1˜Rn and a number of switches SW1˜SWn, and the resistors R1˜Rn and the switches SW1˜SWn cooperatively form a number of current circuits. In the embodiment, the number of the switches SW1˜SWn are corresponding to the number of the buttons 11 respectively.

In the embodiment, the resistors R1˜Rn are connected in series to the first pin 131 of the plug 13, and each two adjacent resistors form a connection node T. The switches SW1˜SWn are respectively connected to one of the connection nodes T and the second pin 132 of the plug 13, or between a last resistor Rn in the series and the second pin 132 of the plug 13. When the control device 10 is connected to the electronic device 20, if one of the buttons 11 is pressed, the switch corresponding to the pressed button is switched on to generate a corresponding conductive current circuit. In the embodiment, when different switch is switched on, the resistors connected to the conductive current circuit is different, namely the resistance of the conductive current circuit is different, which causes the voltage at the voltage detection point C to be different, as a result, different input signals are generated at the voltage detection point C.

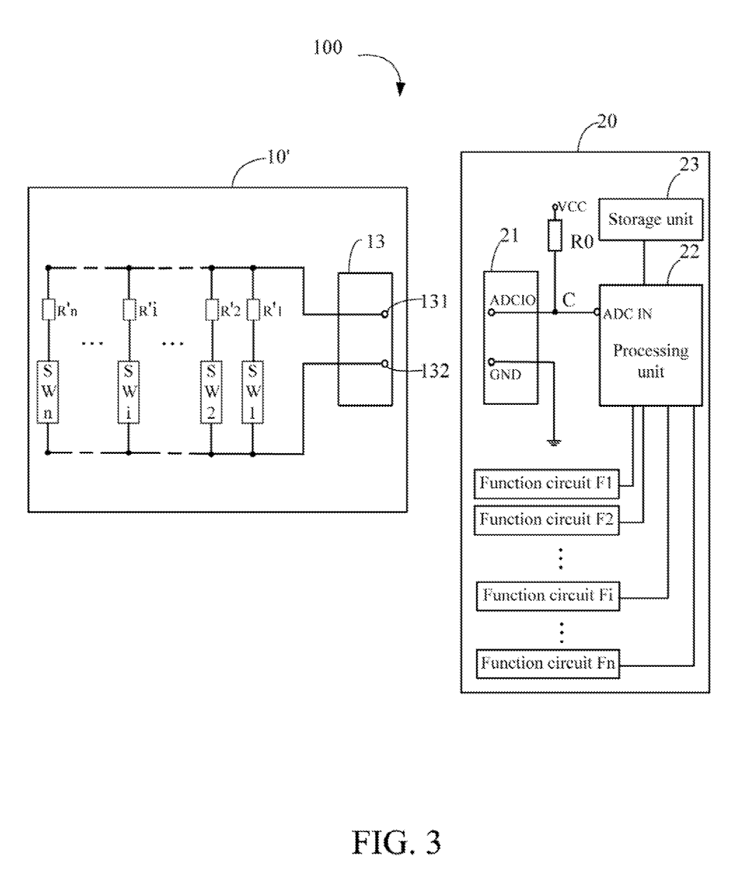

In an alternative embodiment, as shown in FIG. 3, the resistor R′i (i=1, 2, . . . , n) and the switch SWi (i=1, 2, . . . , n) form a series circuit, and the series circuits are connected in parallel to the first pin 131 and the second pin 132 of the plug 13, respectively. In the embodiment, the resistance of the resistors R′1˜R′n is different from each other. When different switch is switched on, the resistance of the conductive current circuit is different, which causes the voltage at the voltage detection point C to be different, as a result, different voltage input signals are generated at the voltage detection point C.

The electronic device 20 executes a corresponding function according to the input signal generated at the voltage detection point C. In the embodiment, the electronic device 20 further includes a processing unit 22 and a number of function circuits F1˜Fn. The function circuit F1˜Fn are corresponding to the buttons 11 respectively. When one of the buttons 11 is pressed to generate a corresponding conductive current circuit, the processing unit 22 receives the input signal and activates the corresponding function circuit.

In the embodiment, the processing unit 22 includes an ADCIN pin connected to the voltage detection point C, to detect the voltage of the voltage detection point C, and activates the corresponding function circuit accordingly.

In the embodiment, the voltage of the power source VCC is U0, when the socket 21 remains floating, the voltage detection point C obtains a voltage U0 via the pull-up resistor R0. When the plug 13 connects to the socket 21, if all the switches SW1˜SWn are switched off, the voltage of the voltage detection point C remains U0. If the button corresponding to the switch SWi (i=1, 2, . . . , n) is pressed to generate a conductive current circuit, and the other switches are switched off, the voltage of the voltage detection point C is changed to Ui (or U′i) (i=1, 2, . . . , n) different from U0.

In the embodiment, the electronic device 20 further includes a storage unit 23. The storage unit 23 stores a relation table (not shown), which records the relationships about the voltage Ui (or U′i) (i=1, 2, . . . , n) of the voltage detection point C and the corresponding function circuit Fi (i=1, 2, . . . , n), namely the voltage Ui (or U′i) (i=1, 2, . . . , n) can activate the function circuit Fi (i=1, 2, . . . , n). For example, if the voltage of the voltage detection point C is U3 (or U′3), the processing unit 22 reads the relation table and activates the function circuit F3, then the function circuit F3 executes a corresponding function.

Moreover, it is to be understood that the disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A control device comprising:
a plug comprising a first pin and a second pin;
a plurality of resistors and a plurality of switches, which cooperatively forming a plurality of current circuits; and
a plurality of buttons corresponding to the plurality of switches respectively.

2. The control device as described in claim 1, wherein the resistors are connected in series to the first pin of the plug, and each two adjacent resistors form a connection node, the switches are respectively connected to one of the connection nodes and the second pin of the plug or between a last resistor in the series and the second pin of the plug.

3. The control device as described in claim 1, wherein the resistors and the switches respectively form a plurality of series circuit, and the series circuits are connected in parallel to the first pin and the second pin of the plug, respectively.

4. The control device as described in claim 3, wherein the resistance of the resistors is different from each other.

5. The control device as described in claim 1, wherein the buttons are push buttons or touch-buttons.

6. A control system comprising:
a control device comprising:
a plug comprising a first pin and a second pin;
a plurality of resistors and a plurality of switches, which cooperatively form a plurality of current circuits; and
a plurality of buttons corresponding to the plurality of switches respectively; and
an electronic device comprising a socket coupled to the plug of the control device, the socket comprising an ADCIO pin coupled to the first pin and a GND pin coupled to the second pin; wherein the ADCIO pin of the socket connects to a power source via a pull-up resistor; a connection node between the ADCIO pin and the pull-up resistor forms a voltage detection point;
wherein, when the control device is connected to the electronic device, if one of the buttons is pressed, the switch corresponding to the pressed button is switched on to generate a corresponding conductive current circuit, as a result, an input signal is generated at the voltage detection point; the electronic device executes a corresponding function according to the input signal.

7. The control system as described in claim 6, wherein the electronic device further comprises a processing unit, which comprises an ADCIN pin connected to the voltage detection point, to detect the voltage of the voltage detection point.

8. The control system as described in claim 7, wherein the electronic device further comprises a plurality of function circuits corresponding to the buttons of the control device respectively, when one of the buttons is pressed, the processing unit activates the corresponding function circuit according to the voltage of the voltage detection point.

9. The control system as described in claim 6, wherein the resistors are connected in series to the first pin of the plug, and each two adjacent resistors form a connection node, the switches are respectively connected to one of the connection nodes and the second pin of the plug or between a last resistor in the series and the second pin of the plug.

10. The control system as described in claim 6, wherein the resistors and the switches respectively form a plurality of series circuit, and the series circuits are connected in parallel to the first pin and the second pin of the plug, respectively.

11. The control system as described in claim 10, wherein the resistance of the resistors is different from each other.
